(19) United States
(12) Patent Application Publication
(10) Pub. No.: US 2011/0301858 A1
(43) Pub. Date: Dec. 8, 2011

(54) SYSTEMS AND METHODS FOR COMPUTER ASSISTED ALIGNMENT OF CONFORMERS

(75) Inventor: Gareth Jones, Boulder, CO (US)

(73) Assignee: Arena Pharmaceuticals, Inc.

(21) Appl. No.: 13/133,915

(22) PCT Filed: Dec. 8, 2009
(86) PCT No.: PCT/US2009/067050

§ 371 Date: Aug. 24, 2011

Related U.S. Application Data
(60) Provisional application No. 61/121,379, filed on Dec. 10, 2008.

(51) Int. Cl. G06F 19/00

(52) U.S. Cl. 702/19

(57) ABSTRACT

A computer-assisted method for determining the optimal conformers of biologically active molecules binding any particular receptor. Starting from a set of molecules of known activity at the receptor a conformer library may be generated using any method known to the art including commercially available software. Pair-wise comparison of conformers create alignments and similarity scoring of the alignments. The set of pair-wise alignments is used by the present invention to determine optimal bioactive conformations and to align these conformations in 3-D space for determining the binding mode of the active compounds The invention includes a computer program implementation of such a method.

### FIELD OF THE INVENTION

The present invention relates generally to the design and development of biologically active molecules. More particularly, certain alignment and compatibility processes may be used with conformer libraries to compare the properties or shape of certain biologically active molecules, such as ligands, to determine pair-wise matches. Such ligands have known activity at a target binding site. This information may be used to infer molecular interactions between the two for the purpose of identifying new molecules with improved or desired activity at the binding site.

Accordingly, the present invention includes a computer-assisted method for combining such pair-wise comparisons of ligands to create a consensus overlay of the chemically significant structural features and geometric relationships that contribute to the binding at the target site. In particular, the invention includes systems, methods which may be embodied as software on a computer-readable medium for using a genetic processing routine or algorithm to generate progressively improving solutions to the conformer matching problem, which may be implemented as one or more computer programs or processing routines.

### BACKGROUND OF THE INVENTION

The development of new or improved pharmaceutical compounds is an unpredictable and empirically driven endeavor. A research team, attempting to develop a treatment for a particular illness, may synthesize and test many different compounds for therapeutic activity. Frequently, even this level of effort does not lead to the development of a successful drug. In view of this complex problem, medicinal chemists today are frequently turning to computational-based molecular modeling to help guide, streamline and reduce the costs of the drug development process.

A biologically active molecule, or “ligand,” functions by binding to a specific molecular receptor located in the cells of an organism. The receptor, in turn, triggers, modulates, or inhibits a specific biological activity of the cell. To enable binding, portions of a biologically active molecule are “recognized” by the receptor. The fit between ligand and receptor binding site is often analogized to the fit of a key in a lock. Not only must the ligand have a chemical structure capable of forming bonds with the atoms of the active site, but the ligand must also be properly geometrically oriented to fit and bind at that site. The geometric arrangement of features such as hydrogen-bond donors and acceptors or hydrophobic groups that are considered necessary for ligand binding is referred to as a “pharmacophore.”

A chemical compound can adopt differing three-dimensional (3-D) shapes or “conformers” due to rotation of atoms about a bond. Conformers can thus interconvert by rotation around a single bond without breaking. A particular conformer of a ligand may provide a complimentary geometry to the active site of the receptor and promote binding.

One representation of a compound used in drug discovery software is a conformer library, where the conformer library contains a set of three-dimensional co-ordinates that describe a number of shapes that the compound can adopt.

The first phase of a drug development program typically involves screening many thousands of compounds for ability to bind to the receptor of interest. If the research team is able to find a number of different molecules that bind to the target receptor, then effort will shift to synthesizing and testing analogs or structurally variants of these “lead” active molecules in an attempt to find additional molecules with improved biological activity. Computational molecular modeling of the lead compounds can provide chemical insight into the structure and geometry of the pharmacophore and guide this optimization effort. The analysis of ligands in the binding site of an experimentally determined target structure is used as a basis to drive the design and development of numerous drugs. The computational exploitation of such an analysis has been an important tool leading to the discovery and development of new drugs. See Hardy, L. W. and A. Maylikayil, “The impact of structure-guided drug design on clinical agents,” Curr. Drug Discov., Dec. (2003): 15-20.

In the absence of a high resolution target/ligand co-crystal structure, however, important interactions between the ligand and target must be inferred either from homology modeling of a high similarity target or by the generation of a binding hypothesis based on the integration of experimental chemistry results which may employ 3-D computational methods. Many tools exist to help derive from a set of input molecules a hypothesis representing a model for the important features involved in protein-ligand interactions. See Bacilieri, M. and S. Moro, “Ligand-based drug design methodologies in drug discovery process: an overview,” Curr. Drug Discov., 3 (2006): 155-65. Key among these tools is the ability to superimpose a set of ligands, so as to reproduce the binding mode of those ligands to the receptor.

3-D molecular alignment techniques, encompassing a number of algorithms, are known in the art. See Bacilieri, Moro; Lemmen, C. and T. Lengauer, “Computational methods for the structural alignment of molecules,” J. Computer-Aided Molecular Design 14.3 (2000): 215-32. Several of these methods are either capable of performing multiple alignment or pair-wise alignment. See Cho S. J. and Y. Sun, “FLAME: A program to flexibly align molecules,” J. Chemical Information and Modeling, 46.1 (2006): 298-306; Jain, A. N., “Ligand-based structural hypothesis for virtual screening,” J. Med. Chem. 47.4 (2004): 947-61; Jones, G., P. Willett and R. C. Glen, “A genetic algorithm for flexible molecular overlay and pharmacophore elucidation,” J. Computer-Aided Molecular Design 9.6 (1995): 532-48; Labute, P., and “Flexible alignment of small molecules,” J. Med. Chem. 44.10 (2001): 1483-90.

Multiple alignment algorithms attempt to better explain ligand binding modes by superimposing a set of active ligands. This is typically a computationally demanding procedure requiring the combined search of ligand conformational space and available super-positions. As such, these algorithms often have difficulty elucidating binding hypotheses for more than five or six compounds.

Known pair-wise alignment algorithms, often embodied in the form of computational software, are able to rapidly superimpose a pair of single ligand conformations. There are a number of commercial products that provide this function. Similarly, conformer generation algorithms, in the form of commercially available software are able to enumerate a conformer library for a ligand.

For example, given four ligands, 50 conformers could be generated per ligand and 40,000 pair-wise alignments between pairs of conformers. It would be advantageous to able to process this information and create an overlay of ligands that is representative of the binding mode of those ligands to the receptor. This is often referred to as “the conformer matching problem.”

In order to create such an overlay, a particular conformer for each ligand is selected. In addition, during this process, it would be advantageous to exclude one or more ligands from the overlay if those ligands cannot not be reasonably included based on acceptable geometric matching paradigms into the current overlay. This gives rise to a combinatorial problem that scales in a substantially non-polynomial fashion with the number of compounds. For example, for 5 ligands and 50 conformers per ligand, there are 3.45×10⁸ (51⁵) conformer combinations, while for 10 ligands there are 1.19×10¹⁷ possible combinations)(51¹⁰).

Generally speaking, exhaustive search algorithms cannot be used in such a context due to the complexity of the underlying problem. However, approximation approaches such as genetic (or other evolutionary) algorithms, simulated annealing, Tabu search, random walks and the like may give reasonable results without evaluating all conformer selection permutations. These search algorithms often employ a scoring function to compare alternative solutions to the underlying problem.

Regardless of the approach used, it would be further desirable to compare conformer selections, so that it can be determined whether a given set of conformers provide a better match than another set of conformers. Such a determination may be based on certain “similarity scores” assigned to conformers based on the pair-wise alignments of the conformers, while ensuring that the set of conformers can be consistently fitted together in 3-dimensional space. This determination may then be used as a scoring function in the algorithms described above.

Once certain molecular conformations are selected, it is desirable to create an overlay of the molecular conformations using the pair-wise alignments of the conformers. The final overlay is intended to be representative of the ligand binding modes.

Accordingly, it would be desirable to provide systems and methods for computer-based simulation methods that solve the conformer matching problem and overcome the shortcomings of conventional approaches.

### SUMMARY OF THE INVENTION

A computer-assisted method for determining the optimal conformers of biologically active molecules binding to a receptor of interest is provided. Starting from a set of molecules of known activity at the receptor, a conformer library is generated using any suitable method known to the art including commercially available software. Pair-wise alignment of the conformers and similarity scoring of those alignments are then generated. For example, if we start with ten active molecules and create 50 conformations per molecule we will have a total of 500 conformers and 250,000 pair-wise alignments and associated similarities. The output of pair-wise comparison is used by the present invention to determine optimal bioactive conformations and to align these conformations in 3-D space for determining the binding mode of the active compounds. The invention includes a method for performing these tasks which may be embodied as computer code or one or more application programs for performing such a method.

In one embodiment, the present invention includes a computer-usable medium having stored therein computer-usable instructions for a processor, wherein the instructions when executed by the processor cause the processor to receive a first data structure describing a plurality of conformers for each biologically active molecule; receive a second data structure describing a plurality of pair-wise conformer alignments and a similarity score for each pair-wise conformer alignment; compute a fitness score of the plurality of conformers based on the similarity score and a penalty score based on geometric properties of each biologically active molecule; and generate a predictive overlay of a plurality of ligands by selecting one or more conformers from each ligand conformer library and combining those conformers into an overlay so as to attempt to reproduce pair-wise alignments between those conformers.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a flowchart illustrating some of the steps involved in decoding a data structure in accordance with an aspect of the present invention;

FIG. 2 is a flowchart illustrating some of the steps involved in determining similarity score in accordance with an aspect of the present invention;

FIG. 3 is a schematic representation of alignments of three conformers in accordance with an aspect of the present invention;

FIG. 4 is a flowchart illustrating some of the steps involved in determining a penalty score in accordance with an aspect of the present invention;

FIG. 5 is a flowchart generally illustrating some of the steps involved in matching conformer pairs accordance with an embodiment of the present invention;

FIG. 6 is a flowchart generally illustrating some of the steps involved in generating a consensus overlay in accordance with an embodiment of the present invention; and

FIG. 7 is a flowchart generally illustrating some of the steps involved in creating consensus coordinates in accordance with an embodiment of the present invention.

### DETAILED DESCRIPTION OF THE INVENTION

One aspect of the present invention employs one more genetic processes or algorithms to solve the conformer matching problem using as input pair-wise comparison of conformers of several molecules having known biological activity at a particular receptor.

Genetic processes, which may be based on certain evolutionary algorithms, use techniques inspired by evolutionary biology such as inheritance, mutation, selection, and crossover that are used to find or approximate solutions to optimization problems. In accordance with aspects of the present invention, a genetic process or algorithm may be implemented as part of a computer simulation in which a population of abstract representations, or chromosomes, of candidate solutions to an optimization problem iterates or evolves progressively towards a more optimal solution. Such chromosomes may be represented by one or more data structures which represent a set of chemical/biological properties.

In each generation, the fitness of each individual in the population may be evaluated, and the most fit individuals may be stochastically selected from the current population and modified (recombined and/or mutated) to form a new population. The new chromosome may then be used in the next iteration of the simulation. The simulation may continue until either a maximum number of generations is produced, or a satisfactory fitness level has been reached for the population.

If the simulation terminates due to a maximum number of generations, a satisfactory solution may or may not have been reached. In this case, the output of the computer simulation will generally represent the most “fit” or “best” conformer of each of the biologically active molecules under consideration (or no conformer if a suitable conformation cannot be found). Computer simulation software in accordance with the principles of the present invention may employ a chromosome representation of the solution domain. The chromosome encoding may be decoded to produce a possible solution to the problem (in this case, a section of ligand conformations). A fitness or scoring function may then be used evaluate the solution domain.

Other search algorithms and techniques may also employ a similar data encoding of the conformer problem and may also benefit from a fitness or scoring function. Such algorithms may include exhaustive search techniques, other evolutionary algorithms, random walks, simulated annealing and Tabu search.

The chromosome representation or data encoding, in one embodiment of the present invention, may use an integer string of length n, where n is the number of molecules of known biological activity at the receptor. Thus, the number of conformers for biologically active molecule x is nx and conformer number i for molecule x is c_{x,i}. The set of conformers may be represented as the set C including {C₁, C₂, . . . Cᵢ} and where Cx is formula 1 below:

Cₓ={C_{x,0},C_{x,2}, . . . C_{x,nx}} (1)

Furthermore, the chromosome representation then may be a chromosome V represented the set V in formula 2 below:

V={v₁,v₂, . . . vₙ}, such that 0≦vᵢ≦ni. (2)

If vᵢ is greater than zero, then the conformer included in the chromosome V for molecule i is vᵢ or c_{i,vi} and the chromosome V comprises a set of conformers with no more than one conformer per molecule.

Accordingly, in view of the above, if 4 known ligands bind to a certain receptor, and each ligand has 20 conformers, then the total number of distinct conformer combinations would be approximately 4.4 E12. One of these 4.4 E12 chromosomes is {2, 13, 0, 9} which includes conformer 2 for molecule 1, conformer 13 for molecule 2, conformer 9 for molecule 4 and no conformer for molecule 3.

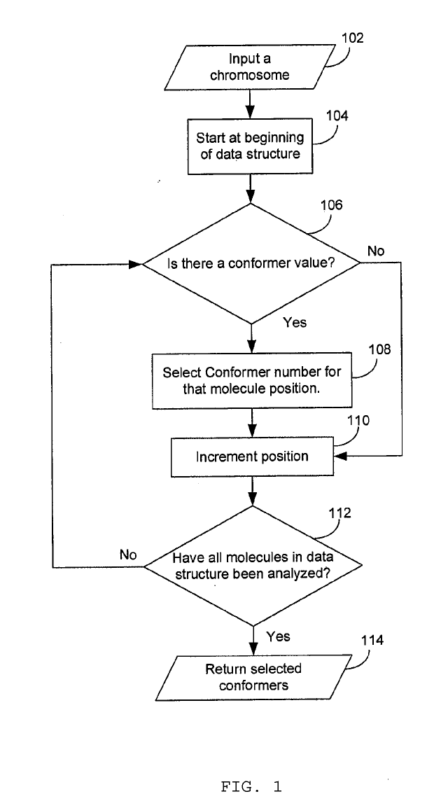

Some of the steps involved in decoding chromosomes in the solution domain in accordance with the present invention are shown in flowchart 100 of FIG. 1. Initially, a set of chromosomes, which may be represented as any suitable data structure, such as an integer string, are provided to the processing software in accordance with one embodiment of the present invention (step 102). As mentioned above, in some embodiments, the length of the integer string is substantially equal to the number of molecules. Further, each position in the chromosome may represent a conformer from that molecule (although any other suitable data arrangement may be used if desired).

At step 104, the first position in the data structure is examined to determine whether conformer exists for that position. If the chromosome does not have a conformer value at the position (e.g., the integer at that position in the data structure is a zero or null) no conformer for that molecule is selected (step 106). However, if there is a value at that position in the data structure, that value is selected as the conformer number for that molecule (step 108). Next at step 110, the position in the data structure is incremented to the next molecule. If all the molecules in a given data structure have been examined (step 112), the results of the decoding process return the selected conformers (step 114). If not, the process returns to step 106.

The fitness function of the present invention may measure the quality of the represented solution (e.g., a measurement of “how well” the ligand conformations selected by the current solution bind at the receptor, in view of certain chemical and geometric properties as further described herein). One objective of the systems and methods herein is to predict the binding conformation of ligands that will bind at the receptor based on the pair-wise alignments between those ligand conformations.

The input to the fitness function of the present invention may include a decoded chromosome as discussed above having one or more conformations of each known bioactive compound, which may be represented by the set CF in formula 3 below. The fitness function may also include some or all of the pair-wise alignments and scores for every pair of conformers in CF (e.g., input data to a software embodiment of the invention). Thus:

CF={c₁,c₂, . . . cₘ} where m≦n; (3)

where pair-wise similarity scores for each pair of conformations in this chromosome are known. A fitness function in accordance with one embodiment of the present invention may then be a normalized product of the pair-wise similarity_score (SS) as set forth in formula 4 below:

SS=1/npΣ^{m}ᵢ₌₁Σ^{m}ⱼ₌ᵢ₊1similarity(c₁,cⱼ). (4)

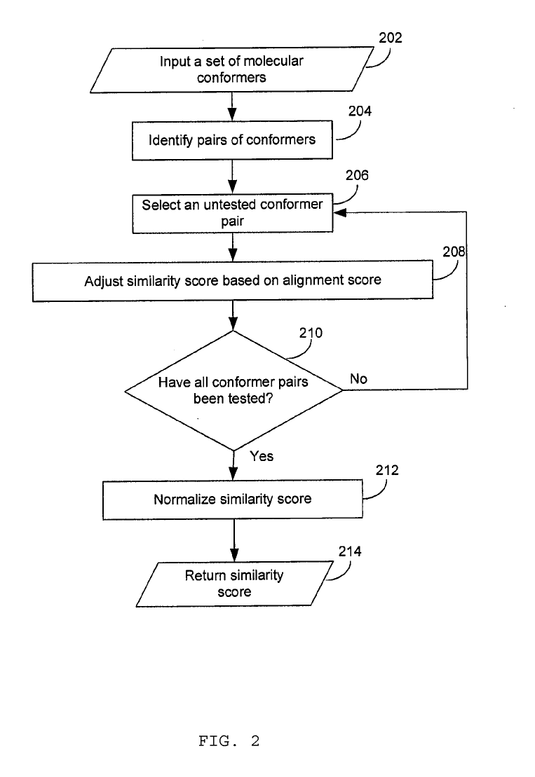

Some of the steps involved in generating a similarity score in accordance with the principles of the present invention are shown in flowchart 200 of FIG. 2. Initially, a set of molecular conformers (which may be represented as any suitable data structure) are provided to the processing software in accordance with one embodiment of the present invention (step 202). These conformers are typically provided from the decoding process illustrated in FIG. 1. At step 204, all conformer pairs of the various different conformers are identified (e.g., using formula (4) above) and the similarity score may be initialized (e.g., set to zero).

Next, an untested pair of conformers is selected (step 206). An alignment score is then retrieved for that conformer pair indicating the quality of the match. The alignment score is generated when the pair-wise alignment is created and thus is part of the input to the program. This may be accomplished using any conventional method, including using known software, such as the ROCS chemical shape and overlay solution from Openeye. The similarity score is then increased by the pair-wise alignment score (step 208). For example, the alignment score may be added to the similarity score, etc.

At step 210, it is determined whether any untested conformer pairs remain. If so, the process returns to step 206. If not, the resulting similarity score may be normalized (e.g., by dividing the similarity score by the number of conformers pair) and the similarity score is generated (step 214).

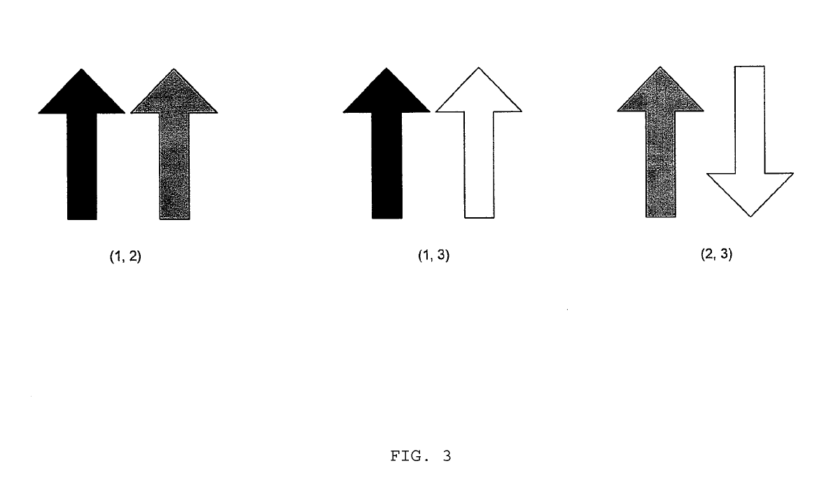

This similarity score, however, does not take into account that some of the pair-wise alignments may be inconsistent with the preferred global alignment at one or more receptor sites. This problem is schematically illustrated in FIG. 3 where the pair-wise similarity score is provided to the fitness function that includes two alignments with conformations of all 3 bioactive molecules shown “pointing” upwards, but, where the third alignment includes either molecule 2 or molecule 3 to be “pointing” downwards. In such a situation, it is generally not possible to align all three molecules in a manner consistent with the three individual pair-wise alignments.

In FIG. 3, assume that the arrowheads represent particular three-dimensional points in the selected conformers. For example, the arrowhead in conformer 1 may be a carbon atom; the arrowhead in conformer 2 may be hetero-atom and the arrowhead in conformer 3 may be a charge-center. The input may include one or more pair-wise alignments for each pair of input conformers. In this example, the pair-wise alignment between conformers 1 and 2 has the carbon atom from conformer 1 overlaid on the hetero-atom on conformer 2 (i.e. the distance between these two features is substantially zero in this alignment).

Likewise, in the alignment between conformers 1 and 3, the carbon atom in conformer 1 may be overlaid on the charge-center in conformer 3 (i.e. the distance between these two features is substantially zero in this alignment). If an overlay is constructed based on the pair-wise alignments of those conformers, the distances between features in the final overlay should be substantially the same as the distances between the same features in the pair-wise alignments.

If the distance between this feature in conformer 1 and the feature in conformer 2 is substantially zero in the pair-wise alignment, and, similarly, the distance between the feature in 1 and the feature in 3 is substantially zero in the pair-wise alignment, it is expected those distances will be substantially zero in the final overlay and therefore the distance between the feature in conformer 3 and the feature in conformer 2 will also be substantially zero.

However, examination of the pair-wise alignment between conformer 2 and conformer 3 may show that the distance between the hetero-atom in conformer 2 and the charge center in conformer 3 is much larger than zero. In this case, it is not clear that a consensus alignment can be constructed from these three pair-wise alignments since these three alignments are collectively inconsistent.

In the case where three conformers each have a single three-dimensional feature, then, using the pair-wise alignments, three distances between any two feature pairs may be obtained. To construct a consistent alignment from the three pair-wise alignments, the larger of the three distances is preferably no greater than the sum of the other two. This is known in the art as the triangle inequality.

A function to penalize violations of the triangle inequality may be defined in equation (5) as:

tri_penalty(a_{i,x},a_{j,y},a_{k,z}) (5)

where a_{i,x} is feature number i in conformer number x. (the function tri_penalty is described below).

In practice, a single feature per conformer is often not sufficient. In some embodiments of the invention hetero-atom centers may be used as feature centers. The number of triangle inequalities (or “triplets”) that can be evaluated for a set of three conformers is the summation across all feature combinations given by equation (6) where kₓ is the number of features in conformer x and where:

$${\sum }_{i = 0}^{{k}_{x}} {\sum }_{j = 0}^{{k}_{y}} {\sum }_{k = 0}^{{k}_{z}} tri\_penalty ( {a}_{i , x} , {a}_{j , y} , {a}_{k , z} ) \qquad ( 6 )$$

In many cases, processing will be performed on three or more conformations. Thus, this calculation may be performed across some or all possible permutations of three conformers, to calculate the penalty score given by equation (7) below:

$$penalty = \frac{1}{nt} \cdot {\sum }_{x = 1}^{m} {\sum }_{y = x + 1}^{m} {\sum }_{z = y + 1}^{m} {\sum }_{i = 1}^{{k}_{x}} {\sum }_{j = 1}^{{k}_{y}} {\sum }_{k = 1}^{{k}_{z}} tri\_penalty ( {a}_{i , x} , {a}_{j , y} , {a}_{k , z} ) \qquad ( 7 )$$

where nt is a normalization equal to the number of triplets evaluated.

Thus, to address this problem, an embodiment of the present invention provides a fitness score based on the similarity score that incorporates a penalty term based on a certain geometric properties of the conformers. In some embodiments, a triangle inequality constraint is used, but any other suitable geometric consideration may be used, in place of, or in combination with, the triangle inequality, if desired. For example, distance geometry constraints based on four or more feature points. In some embodiments, combining other geometric considerations with the triangle inequality, may produce more precise results.

Generally, triangle inequality constraints are based on the geometric property of triangles that the longest side of the triangle must be less than the sum of the two shorter sides. Accordingly, the quality of the conformer match can be further refined by applying this principle to an initial group of conformer solutions, which is indicated by the fitness score disclosed herein. For example, the fitness score is not penalized if the triangle inequality constraint is met (indicating a higher quality match), if not, the fitness score is reduced (indicating a lower quality match). In the case where other geometric considerations are used, they may be employed after (or before) the triangle inequality test is applied to the conformer set.

In order to take into account violations of the triangle inequality constraint, the penalty term of formula 8 below may be introduced to fitness scores of the present invention to determine the relative quality of the match as further described herein. For example, tri_penalty may be defined as:

tri_penalty(a_{i,x},a_{j,y},a_{k,z}) (8)

where x, y and z are conformers and x≠y≠z, and where each of a_{i,x}, a_{j,y}, and a_{k,z} are readily identifiable atoms or other 3-D structural features of the bioactive ligands included in the input to the simulation program. The feature a_{i,x} may be feature i in conformer x where a feature is either a carbonyl carbon or hetero-atom, etc. Additionally, the penalty score may be further modified to reflect the outcome of any other geometric considerations used in analyzing the conformer pair of interest (not shown).

Continuing to consider a situation where three conformations of known bioactive molecules together with the three pair-wise alignments between those conformations are provided as input to a computer program of the present invention, the three distances (a_{i,x}, a_{j,y}), (a_{i,x}, a_{k,z}) and (a_{j,y}, a_{k,z}) may be determined from the input pair-wise alignments. The difference between the longest of these distances and the sum of the two shorter distances may be then also be calculated (as the variable diff). Accordingly, if diff<0, tri_penalty returns a value of 0.0, otherwise tri_penalty returns a value of (diff).

At this point, the penalty value for a selected chromosome may be computed by summing the values of tri_penalty across all conformer triplets and feature triples (a_{i,x}, a_{j,y}, a_{k,z}), where kx is the number of features in conformer x and nt is the number of such triplets evaluated according to formula 7 above.

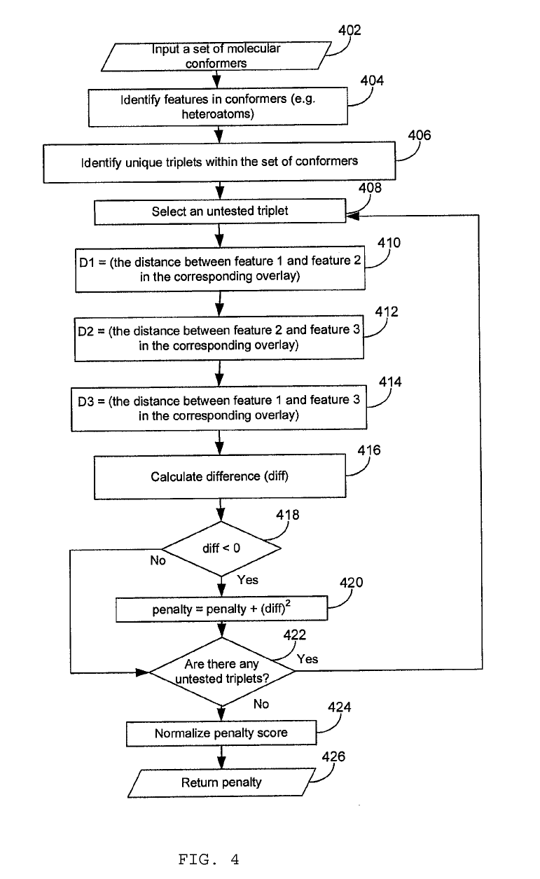

Some of the steps involved in generating a penalty score in accordance with the principles of the present invention are shown in flowchart 400 of FIG. 4. Initially, the penalty score is initialized and a set of molecular conformers (which may be represented as any suitable data structure) are provided to the processing software of the present invention (step 402). These conformers are typically provided from the decoding process illustrated in FIG. 1. At step 404, some or all of the geometric features of the various different conformers are identified (e.g., atom centers, donor or acceptor sites, hydro-phobes and/or hetero-atoms).

At step 406, feature triplets that can be tested against the triangle inequality (and/or other geometric properties) are enumerated (as detailed in the summation in equation 7 above). Next, at step 408 any untested triplet is identified. This untested triplet contains three features: feature 1 in conformer A, feature 2 in conformer B and feature 3 in conformer C. At step 410, the pair-wise overlays generated by the alignment tool such as the ROCS tool in FIG. 2, determine the distance D1 between feature 1 in conformer A and feature 2 in conformer B. Similarly, the distance D2 between feature 2 in conformer B and feature 3 in conformer C is determined (step 412) along with the distance D3 between feature 1 in conformer A and feature 3 in conformer C (step 414).

In order to fit the three conformers together in space using the three pair-wise alignments above, features 1, 2 and 3 form a triangle. The three distances D1, D2 and D3 are then tested for violations of the triangle inequality (e.g., whether the longer of the three sides is less than the sum of the other two). The difference between the longest of the three distances and the sum of the other two sides is then determined (step 416). This difference value may be stored in the variable diff.

If the difference is less than zero at step 418 then the triangle inequality is satisfied and the process proceeds to step 422. No adjustment is made to the penalty score (in some embodiments, additional geometric tests may be performed at this point). However, if the difference value is greater than or equal to zero, the triangle inequality is violated and the penalty score is incremented by the square of the difference value (step 420). The results of any additional tests, if performed, may also be incorporated into the penalty score.

At this point, it is determined whether any untested triplets remain (step 422). If so, the process returns to step 408. If not, the penalty score is normalized (i.e., by dividing the raw penalty by the number of triplets tested (step 424), and the normalized penalty score is generated (step 426). This score is identical to penalty described in equation (7) above.

This allows a fitness score for a given conformer to be calculated by subtracting the penalty value generated by formula 7 from the similarity_score generated by formula 4 as set forth in formula 10 below:

fitness=similarity_score−penalty (10)

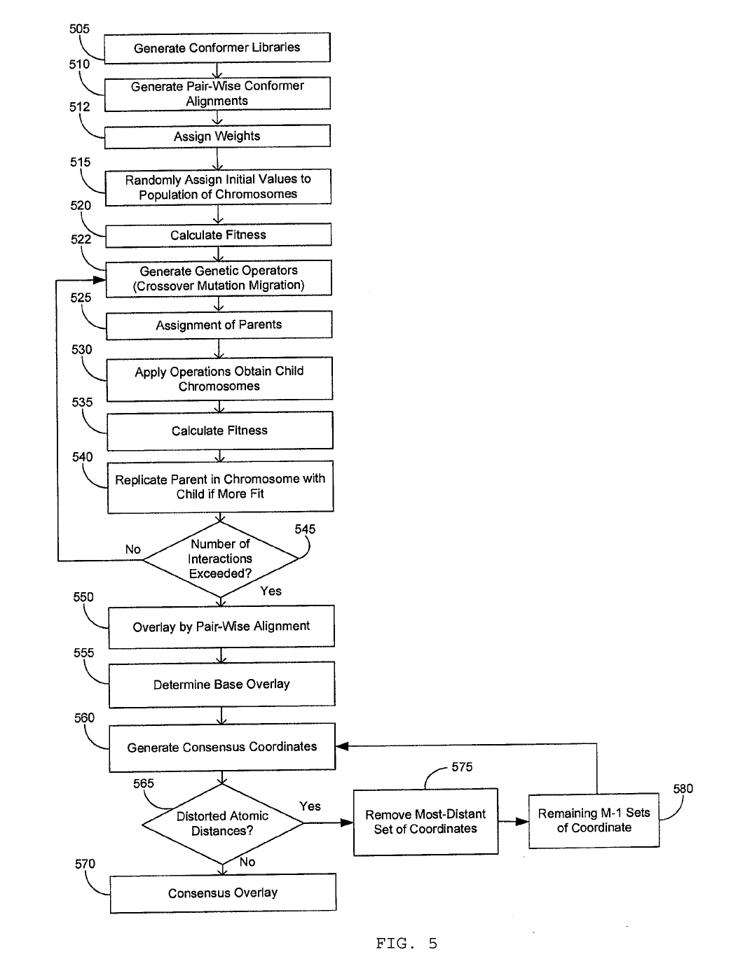

One embodiment of the present invention may utilize a genetic algorithm or process with the chromosomes and the fitness function as described above in accordance with the method illustrated in the flowchart 500 of FIG. 5 to a generate a consensus overlay of “best-fit” conformers. These “best-fit” conformers are more likely to perform as desired by the molecule designers due to the more comprehensive and complete match at the target site.

As shown in FIG. 5, initially, starting with a set of known bio-active molecules, a conformer library for each input molecule is generated (step 505). This may be accomplished using any suitable method, including using known conformer generator software and/or databases such as such as OMEGA from Openeye. Next, at step 510, scored pair-wise alignments and associated similarity scores are generated between all pairs of conformers in the libraries. This also may be accomplished using any conventional method, including using known software, such as the ROCS chemical shape and overlay solution from Openeye.

While FIG. 5 describes a genetic process, using the scoring function described above, and any suitable search algorithm, a set of molecular conformations that score well in the fitness function may be obtained.

At step 515, initial values may be randomly assigned to chromosomes, using any suitable linear random number generator. At this point, an initial fitness score of the randomly initialized chromosomes may be calculated as described above.

Next, at step 525, existing chromosomes or “parents” are selected based on the fitness scores generated a step 520. For example, in certain embodiments, the parents may be selected using on a normalized, rank-based, linear selection scheme with a predefined value for selection pressure (i.e., the ratio of the normalized, linearly-scaled fitness score for the best fit chromosome to the scaled fitness score for the least fit chromosome). A low selection pressure, on the order of about 1.001 may be preferred because this low selection biases the process towards a fuller exploration of the search space rather than rapid optimization to a possibly sub-optimal solution.

These scaled fitness scores may be used as a starting point from which to select parents for the genetic operators using a stochastic selection process (e.g., a roulette wheel parent selection). One parent selection scheme that may be employed includes a roulette wheel approach with each chromosome being assigned a section of the wheel proportional to the scaled fitness score of that chromosome.

After parent chromosomes are selected, at step 530, genetic operators may be applied to the population to obtain child chromosomes (at steps 585 and 590). Such genetic operators randomly modify the parents over a number of generations until an optimal solution is obtained or until a preset number of operations are applied. In one embodiment of the invention, an island model may be employed having independently evolution sub-populations. For example, one embodiment, an island model may include 5 independently evolving sub-populations of 100 chromosomes each.

As shown in FIG. 5, at steps 522 through 545, additional chromosome generations may be iterated by employing a combination of crossover, mutation and migration genetic operators. In one embodiment, 60,000 genetic operators may be applied during this iterative procedure (although other amounts of operators may be applied, if desired, to achieve certain performance or precision goals). In each iteration, a genetic operator may be selected using a stochastic method such as a roulette wheel selection. For example, a roulette wheel selection process may apply operator weights of 95 for each of crossover and mutation and 10 for migration (step 512 to assign the weights and step 522 to select the operator). This weighting results in crossover and mutation each being applied 47.5% of the time, on average, and migration being applied 5% of the time. Application of the operators (step 530) produces child chromosomes which then replace the least fit chromosomes in each island sub-population at each iteration (step 540). As iterations proceed, progressively more fit children, encoding better sets of conformations, populate the chromosomes.

In accordance with one embodiment of the invention, a two-point crossover operator may be employed at step 530 that operates on two parent chromosomes and produces two child chromosomes. With this approach, two different cross points may be selected at random along the length of each of the integer strings comprising the two parent chromosomes. The first child chromosome may have the integer string of the first parent before the first cross-point and after the second cross-point and may have the integer string of the second parent between the cross points. Similarly, the second child may have the integer string of the second parent before the first cross-point and after the second cross-point and may have the integer string of the first parent between the cross points. However, any other suitable crossover mutation scheme may be used, if desired.

Moreover, a mutation operator for use in an embodiment of the present invention may operate on one parent chromosome and produces one child chromosome. The child integer string preferably differs from the parent by at least one random perturbation. The probability of mutation for each integer position on the parent string of length L integers is 1/L. If after operating on the entire string no mutation is applied the operation is repeated until at least one mutation occurs.

Moreover, in an island model implementation, the migration operator may operate on two island sub-populations randomly selected by the operator. In this case, the operator may select one parent chromosome from the first island sub-population using roulette wheel parent selection and copies that parent chromosome to the second island.

After the child chromosome or chromosomes are created by any operation, the fitness score of each such chromosome may be calculated as described herein (step 535). These fitness scores may be compared with the fitness scores associated with the parent chromosomes to determine which chromosome is more fit. If the child chromosome is more fit than the parent, it replaces the parent. In the case where the parents' similarity score is higher, it remains in the population and the child is discarded. This process may be repeated until an optimal solution is obtained or a present number of iterations occurs (step 545).

In some embodiments of the invention, as an alternative to the genetic algorithm described herein, the fitness function may be incorporated into other processes such as those described earlier. One aspect of the present invention employs the fitness function in a depth-first exhaustive search algorithm that can be used to process rigid ligands.

Upon completion of the genetic algorithm or other search procedure the best set of conformers of the biologically active molecules under consideration is obtained. From this set of conformers an overlay, containing consensus conformation can be generated to predict optimal binding conformation which may be used to guide synthesis of further compounds expected to bind the receptor and that may be more bioactive and/or selective for the receptor.

An overlay may be created for each of the m conformers of the output set of the genetic algorithm using pair-wise alignments. Considering conformer c₁, for example, the pair-wise alignment of (c₁, c₂) is used to align c₂ to c₁. The pair-wise alignment for (c₁, c₃) may then be used to align c₃ to c₁ generating an overlay of c₁, c₂ and c₃. This procedure is iterated m−1 times generating an overlay of all m conformers based on c₁. This iterative process is repeated for each of the other m−1 conformers providing a set of m overlays.

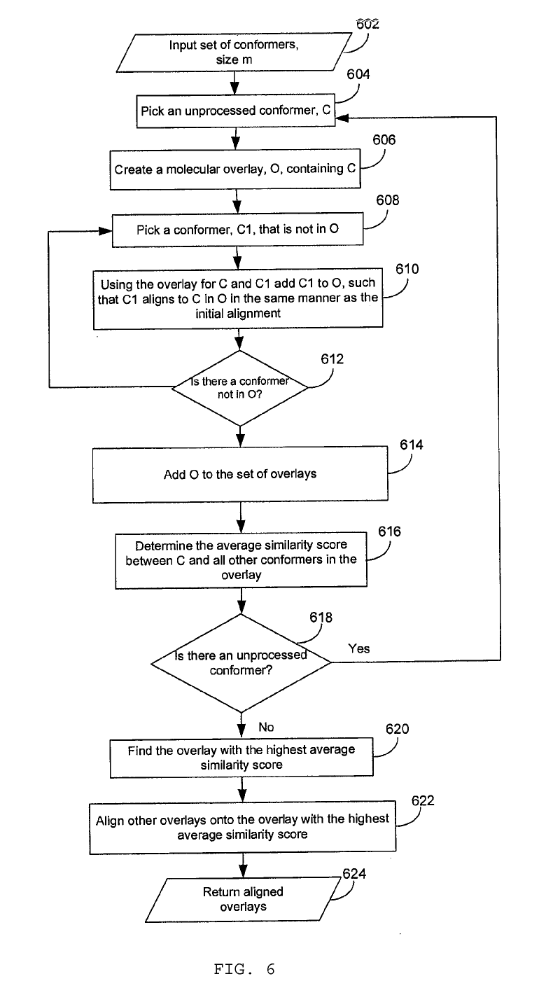

For example, some of the steps involved in generating one or more molecular overlays in accordance with the principles of the present invention are shown in flowchart 600 of FIG. 6. At step 602, the overlay set is initialized and a set of molecular conformers, each of which may represent a different molecule, are provided to the processing software of the present invention. These conformers are typically provided from the decoding process illustrated in FIG. 1.

At step 604, an unprocessed conformer C is selected. At step 606, a molecular overlay O may be created based on the selected conformer C from pair-wise alignments with the other conformers created by any suitable commercially available molecular overlay software such as ROCS or method known in the art. One way this may be accomplished is by selecting another conformer, C1 that is not included in the original overlay generated for C, and generating a second overlay O1 (step 608). O1 may then be added to O such that C1 aligns to C in O in the substantially the same orientation as the initial (ROCS) pair-wise alignment (step 610).

In some embodiments of the invention, this is performed by creating a least-squares fitting transform such that C in the ROCS overlay is fitted onto C in O, the transform is then applied to C1 in the ROCS overlay to create co-ordinates for C1 to add to O. At step 612, it is determined whether there are any more conformers to be added to overlay O. If yes, return to step 608. If not, proceed to step 614, where O is added to the set of computed overlays.

At step 616, the average similarity score between conformer C and the other conformers in overlay O is determined. If all conformers have been processed at step 618, proceed to step 620 where the overlay with the highest average similarity score is identified. If not, return to step 604 to create another overlay. Next, at step 622, the other overlays are aligned onto the overlay having the substantially highest similarity score (e.g., using a least squares fitting algorithm). Lastly, at step 624 a set of aligned overlays is generated.

For each conformer the average similarity with the other conformers in the set may be determined. The overlay based on the conformer with the highest similarity score is selected as the base overlay (step 555). Each of the other m−1 overlays may then be least-squares fitted onto to this base overlay, as detailed above. The m overlays may then be commonly aligned with m sets of coordinates for each of the m conformers.

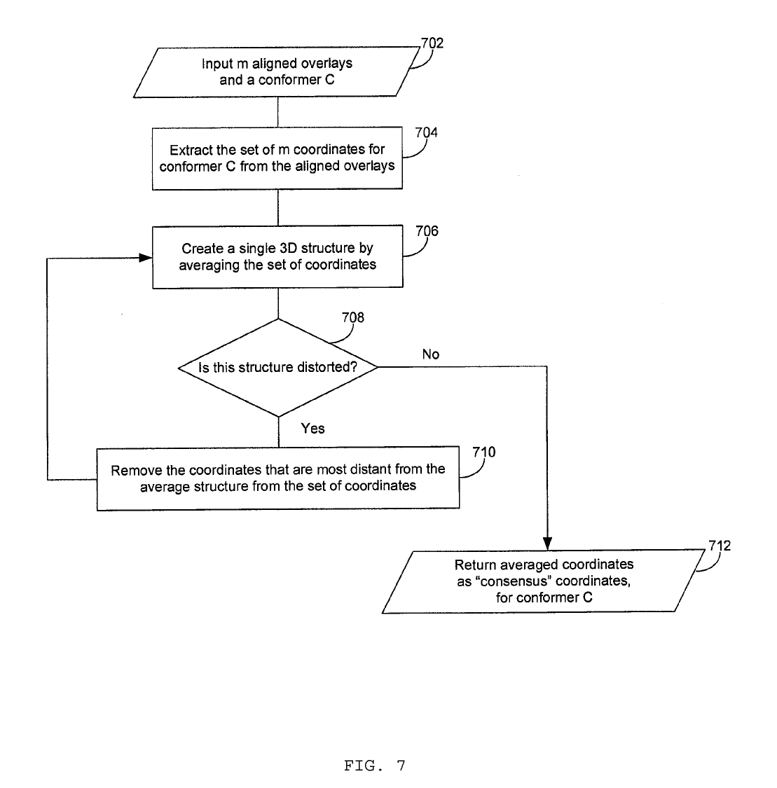

Consensus coordinates are then generated for each conformer (step 560) as illustrated in FIG. 7 (described below). The average of the m sets of coordinates for each of the m conformers is computed. At this point, a check is performed to determine if the average coordinates represent a distorted chemical structure (step 565).

In accordance with one embodiment of the invention, distorted structure may be determined by computing the shortest inter-atomic distances of atoms in the conformer separated by at least 5 bonds. Each such distance may then be compared to the distance between the same atoms in the corresponding conformer determined above. The average structure may be considered undistorted if the mean distance difference for all such inter-atomic distances is less than a predetermined distance (e.g., about 0.25 Å).

If the average coordinates represent an undistorted chemical structure then those coordinates are output as the consensus overlay for that conformer (step 570). If the structure is distorted, the molecular coordinates most distant from the average coordinates may be removed (step 575) and the remaining m−1 sets of coordinates are used to generate a new set of average coordinates (step 580). This process may be repeated until the average coordinates are no longer considered distorted and that set of average coordinates is output as the consensus overlay for that conformer (step 570).

Some of the steps involved in generating consensus coordinates for one or more conformers in accordance with the principles of the present invention are shown in FIG. 7. As shown, at step 702, a set of aligned overlays and a conformer are provided (e.g., the output of the process 600 shown in FIG. 6). Next at step 704, a set of coordinates for the conformer are extracted from the overlay. Next, at step 706, a single three-dimensional structure may be created. This structure is analyzed to determine whether it is distorted or otherwise considered irregular (step 708). This may be accomplished as described above, (e.g., by determining if the mean distance difference for some or all inter-atomic distances is greater than a predetermined distance (e.g., about 0.25 Å) or the greater than the average of the coordinate structures).

If it is determined that the structure is distorted, the coordinates that are most distant from the average structure are removed from the conformer coordinates (step 710) and the average is recalculated (by returning to step 706). If it is determined that the structure is not distorted or otherwise irregular, then average consensus coordinates for that conformer are returned (step 712).

Systems and methods described herein, such as those illustrated in FIGS. 1-7 may be embodied in or comprise software, firmware, hardware, or any combination(s) of software, firmware, or hardware suitable for the purposes described herein. Software and other associated logic may reside on servers, workstations, personal computers, computerized tablets, personal digital assistants (PDAs), and other devices suitable for the purposes described herein. Software and other associated logic may be accessible via local memory, via a network, via a browser or other application in an application service provider (ASP) context, or via other means suitable for the purposes described herein. Data structures described herein may comprise computer files, variables, programming arrays, programming structures, or any electronic information storage schemes or methods, or any combinations thereof, suitable for the purposes described herein. User interface elements for use with present invention may comprise elements from graphical user interfaces, command line interfaces, and other interfaces suitable for the purposes described herein.

Aspects of the present inventions described herein may be embodied as computer-executable instructions, such as routines executed by a general-purpose computer, e.g., a server computer, wireless device or personal computer. Those skilled in the relevant art will appreciate that the invention can be practiced with other communications, data processing, or computer system configurations, including: Internet appliances, hand-held devices (including personal digital assistants (PDAs)), wearable computers, all manner of cellular or mobile processing systems, multi-processor systems, microprocessor-based or programmable consumer electronics, set-top boxes, network PCs, mini-computers, mainframe computers, and the like.

Aspects of the invention can be embodied in a special purpose computer or data processor that is specifically programmed, configured, or constructed to perform one or more of the computer-executable instructions described herein. Aspects of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., flash memory, EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

It should be noted that various changes and modifications to the presently preferred embodiments described herein will be apparent to those skilled in the art. Such changes and modifications may be made without departing from the spirit and scope of the present invention and without diminishing its attendant advantages.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

Nothing that has been stated or illustrated is intended to cause a dedication of any component, step, feature, object, benefit, advantage, or equivalent to the public, regardless of whether it is recited in the claims.

In short, the scope of protection is limited solely by the claims that now follow. That scope is intended to be as broad as is reasonably consistent with the language that is used in the claims and to encompass all structural and functional equivalents.

While the specification describes particular embodiments of the present invention, those of ordinary skill can devise variations of the present invention without departing from its inventive concept.

1. A method for generating an overlay for binding to a receptor in a custom apparatus comprising a processor and a memory, the method comprising:
receiving, in the memory, data describing structures of a plurality of conformers from two or more molecules that bind to the receptor and
data describing an alignment for each pair of the conformers and a similarity score for the alignment
calculating, by the processor, for each of the conformers a fitness score based on the similarity scores and a penalty score based on geometric properties of the corresponding molecule, thereby
generating an overlay for binding to the receptor by combining one or more conformers from each of the two or more molecules, wherein the one or more conformers are selected based on the fitness scores and penalty scores of the conformers.

2. The method of claim 1, wherein the penalty score is determined based on distance geometry techniques.

3. The method of claim 2 wherein the distance geometry technique comprises a triangle inequality test.

4. The method of claim 1 further comprising normalizing the penalty scores.

5. The method of claim 1 further comprising normalizing the similarity scores.

6. The method of claim 1 further comprising determining, after the overlay is generated, whether the overlay produces a distorted chemical structure.

7. The method of claim 6 further comprising removing substantially all distant atomic coordinates from the overlay if a distorted chemical structure is produced and regenerating the overlay.

8. The method of claim 7 further comprising repeating the removing and regenerating steps until a non-distorted chemical structure is produced.

9. The method of claim 8 wherein a non-distorted chemical structure is produced when calculated mean distance difference is at or below a predetermined value.

10. The method of claim 8 further comprising generating a consensus overlay based on the non-distorted chemical structure.

11. A non-transitory computer-readable medium having stored therein computer-readable instructions, wherein the instructions when executed by a processor cause the processor to:
receive data describing structures of a plurality of conformers from two or more molecules that bind to the receptor and data describing an alignment for each pair of the conformers and a similarity score for the alignment; and
calculate for each of the conformers, a fitness score based on the similarity scores and a penalty score based on geometric properties of the corresponding molecule, thereby generating an overlay for binding to the receptor by combining one or more conformers from each of the two or more molecules, wherein the one or more conformers are selected based on the fitness scores and penalty scores of the conformers.

12. The non-transitory computer-readable medium of claim 11 further comprising computer-readable instructions which when executed by the processor cause the processor to determine the penalty score based on distance geometry techniques.

13. The non-transitory computer-readable medium of claim 12 wherein the distance geometry techniques comprise a triangle inequality test.

14. The non-transitory computer-readable medium of claim 11 further comprising computer-readable instructions which when executed by the processor cause the processor to normalize the penalty scores.

15. The non-transitory computer-readable medium of claim 11 further comprising computer-readable instructions which when executed by the processor cause the processor to normalize the similarity scores.

16. The non-transitory computer-readable medium of claim 11 further comprising computer-readable instructions which when executed by the processor cause the processor to determine, after the overlay is generated, whether the overlay produces a distorted chemical structure.

17. The non-transitory computer-readable medium of claim 16 further comprising computer-readable instructions which when executed by the processor cause the processor to remove substantially all distant atomic coordinates from the overlay if a distorted chemical structure is produced and regenerate the overlay.

18. The non-transitory computer-readable medium of claim 17 further comprising computer-readable instructions which when executed by the processor cause the processor to repeat the removing and recalculating steps until a non-distorted chemical structure is produced.

19. The non-transitory computer-readable medium of claim 17 further comprising computer-readable instructions which when executed by the processor cause the processor to determine that a chemical structure is non-distorted when a calculated mean distance difference is at or below a predetermined value.

20. The non-transitory computer-readable medium of claim 18 further comprising computer-readable instructions which when executed by the processor cause the processor to create a consensus overlay based on the non-distorted chemical structure.

21. A custom computing apparatus comprising:
a processor;
a memory coupled to the processor;
a storage medium in communication with the memory and the processor, the storage medium containing a set of processor executable instructions that, when executed by the processor configure the custom computing apparatus to generate an overlay for binding to a receptor, comprising a configuration to:
receive, in the memory, data describing structures of a plurality of conformers from two or more molecules that bind to the receptor and data describing an alignment for each pair of the conformers and a similarity score for the alignment;
calculate, by the processor, for each of the conformers, a fitness score based on the similarity scores and a penalty score based on geometric properties of the corresponding molecule, thereby generating an overlay for binding to the receptor by combining one or more conformers from each of the two or more molecules, wherein the one or more conformers are selected based on the fitness scores and penalty scores of the conformers.
